(19) United States
(12) Patent Application Publication
(10) Pub. No.: US 2015/0260309 A1
(43) Pub. Date: Sep. 17, 2015

(54) Long Handled Valve Actuator For Opening And Closing Buried Valves

(71) Applicant: James Fitzgerald, Childersburg, AL (US)

(72) Inventor: James Fitzgerald, Childersburg, AL (US)

(21) Appl. No.: 14/209,537

(22) Filed: Mar. 13, 2014

(51) Int. Cl. F16K 31/60

(52) U.S. Cl. CPC F16K 31/607

(57) ABSTRACT

The long handled valve actuator for opening and closing a deep buried valve when said valve is located underground. This long handled valve actuator has a long tee handle and a bottom horizontal bar which has two clevises (inverted “U” shaped members) attached on each end to fit over a butterfly handle on the valve to be operated.

### REFERENCE TO RELATED APPLICATIONS

This patent application claims the benefit of U.S. Provisional Application No. 61/845,471 filed on Jul. 12, 2013, the disclosure of which is incorporated herein by reference in its entirety.

### BACKGROUND OF THE INVENTION

1. Field of the Invention

The present invention relates generally to a tool for the operation of a valve, and more particularly to a long handled valve actuator for opening and closing deep buried valves.

2. Description of Related Art

Butterfly handled valves sometimes are buried deep into the mud, water, snow or certain places not easy to access and operate by hand. In the known tools for opening valve structure, there are no known commercially available tools which are designed to be portable and readily adaptable for such purposes. Accordingly, what is needed is a tool that can access these deep buried valves and operate them as desired.

### SUMMARY OF THE INVENTION

The tool of the present invention can be used to operate buried valves in residential and commercial sprinkler systems, agricultural irrigation systems, wells, swimming pools, sewer plants. It can turn levers on anything it fits on.

The valve actuator of the present invention has a handle with a long shaft, a horizontal bar attached at the bottom of the handle and two inverted “U” shaped members (referred as “clevises” in the specification hereinafter) attached to the horizontal bar on each side of the shaft. The clevises are designed to fit on the butterfly handle of the valve to be operated. The valve actuator of the present invention has a handle at top of shaft to be turned thus operating the valve.

The present invention is an improvement on what currently exists. It uses two clevises and thus prevents breaking butterfly handles on the valve. The current ones break PVC valve handles making them inoperable. The present invention will open most broken handled valves as well.

A user simply find the valve and place the bottom two clevises on the butterfly handle on the valve and twist the top handle to operate the valve.

Using this invention affords the user unlimited access to operate deep buried valves. The adjustable length of shaft brings the tool into the desired height so that the user can easily maneuver the tool to open or close the valve without much effort.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows.

Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a perspective view of a long handled valve actuator according to an embodiment of the present invention as well as several valves of various sizes.

FIG. 2 is a close-up view of the tee-handle of the embodiment shown in FIG. 1.

FIG. 3 is a close-up view of clevises attached to the bottom horizontal bar of the embodiment shown in FIG. 1.

FIG. 4 illustrates the use and operation of the valve actuator according to the present invention.

FIG. 5 is a close-up front view of clevises fit on a valve's butterfly handle.

FIG. 6 is a close-up bottom view of clevises of the embodiment of FIG. 1.

FIG. 7 illustrates making of the valve actuator of the embodiment of FIG. 1.

FIG. 8 is a close-up side view of clevises of the embodiment of FIG. 1.

FIG. 9 is a front view of a valve actuator according to another embodiment of the present invention.

FIG. 10 is a front view of a valve actuator according to another embodiment of the present invention.

### DESCRIPTION OF THE PREFERRED EMBODIMENT

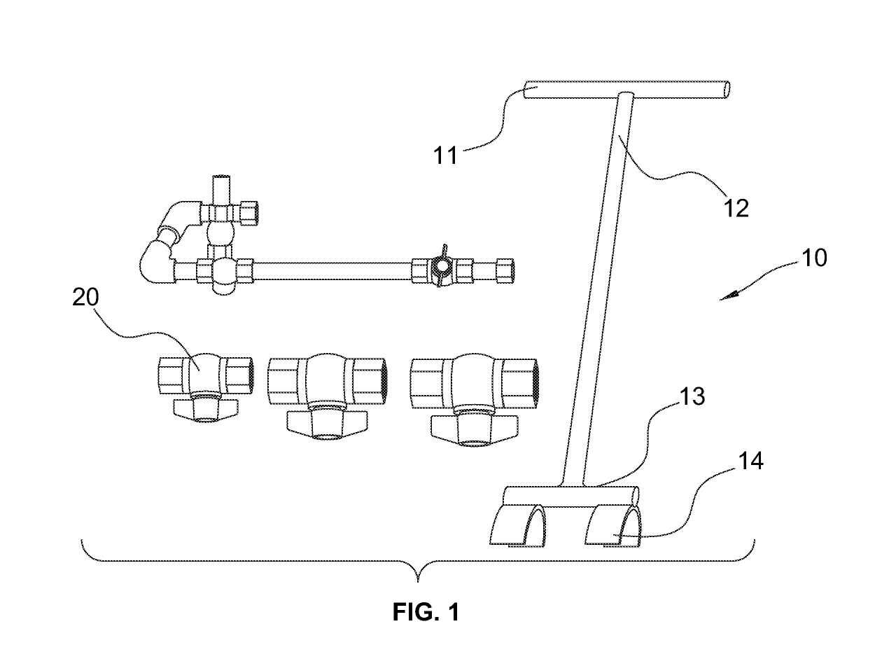

Referring to FIG. 1, there is disclosed a long handled butterfly valve actuator for opening and closing valves that are not easily accessed such as valves underwater, in mud, snow, buried in deep, etc.

FIG. 1 is a perspective view of a valve actuator 10 according to an embodiment of the present invention as well as several valves with butterfly handles 20 of various sizes. The valve actuator 10 is one single unit in FIG. 1.

The long handled valve actuator 10 for opening and closing a deep buried butterfly handled valve comprises a tee handle which has a horizontal bar 11 and a vertical shaft 12. The vertical shaft 12 (or elongated member) is perpendicularly connected at its top to the center of the horizontal bar 11. The long handled valve actuator 10 further comprises a bottom horizontal bar 13 which is perpendicularly connected at its center to the bottom of the tee handle shaft 12 and parallel with the tee handle horizontal bar 11. Two clevises 14 are attached to the bottom horizontal bar 13 on each side at a pre-determined distance. These two clevises are designed to fit over butterfly handles of valves to be operated.

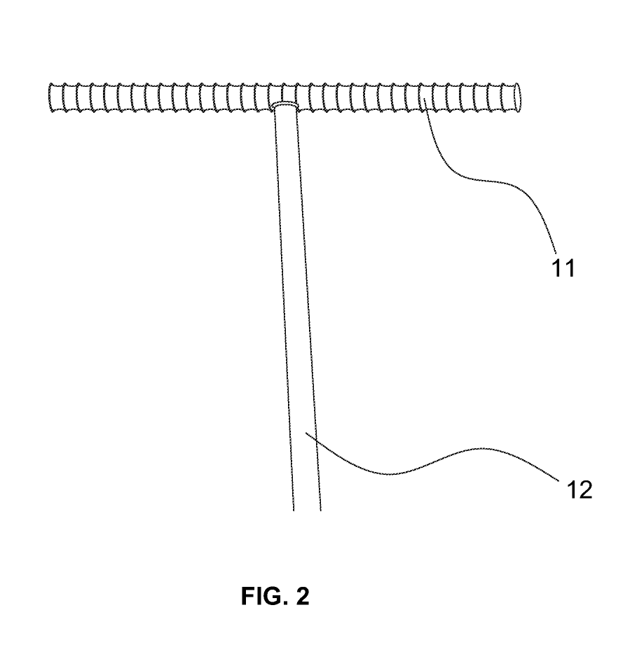

FIG. 2 is a close-up view of the tee-handle of the embodiment shown in FIG. 1 which has a horizontal bar 11 and vertical shaft 12. The vertical shaft is connected to the tee handle horizontal bar by welding.

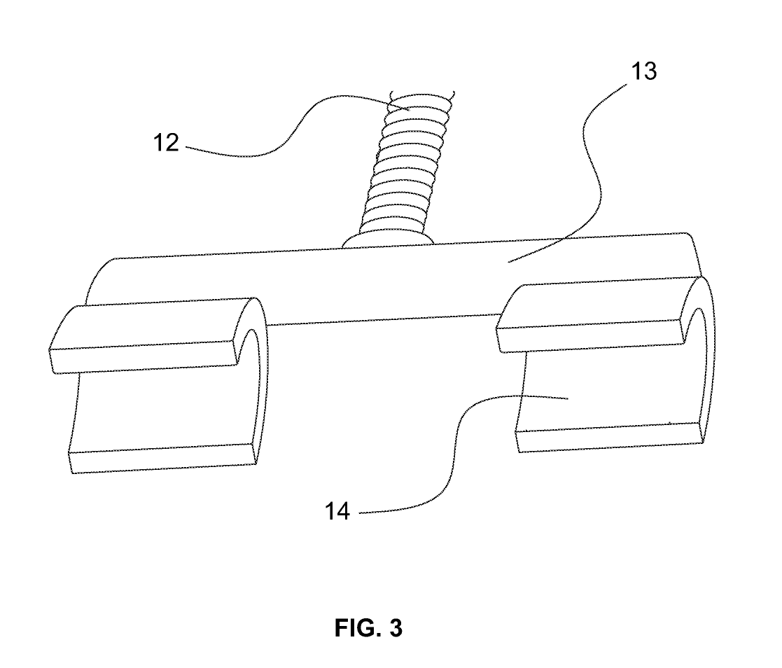

FIG. 3 is a close-up view of clevises 14 attached to the bottom horizontal bar 13 of the embodiment shown in FIG. 1. The bottom horizontal bar 13 is welded to the bottom of the shaft 12 and clevises 14 are welded to the bottom horizontal bar 13.

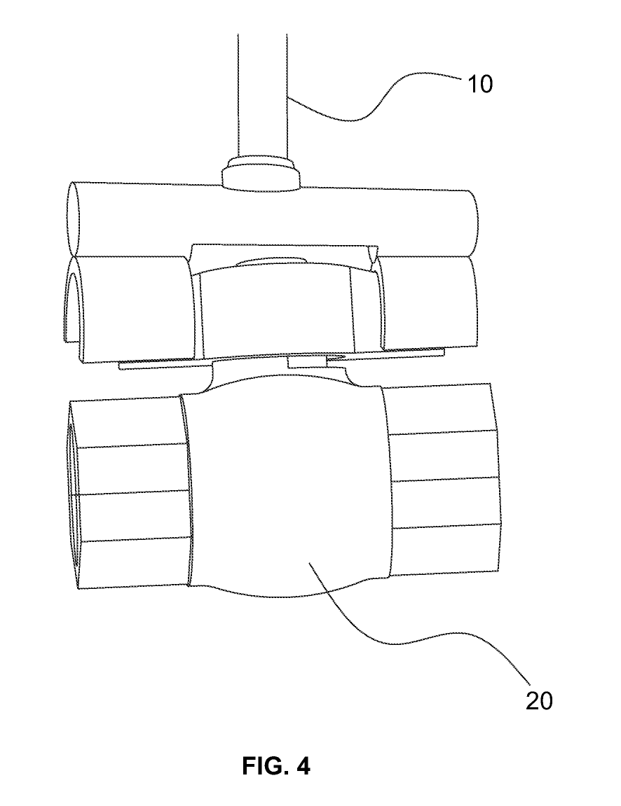

FIG. 4 illustrates the use and operation of the valve actuator 10 according to the present invention.

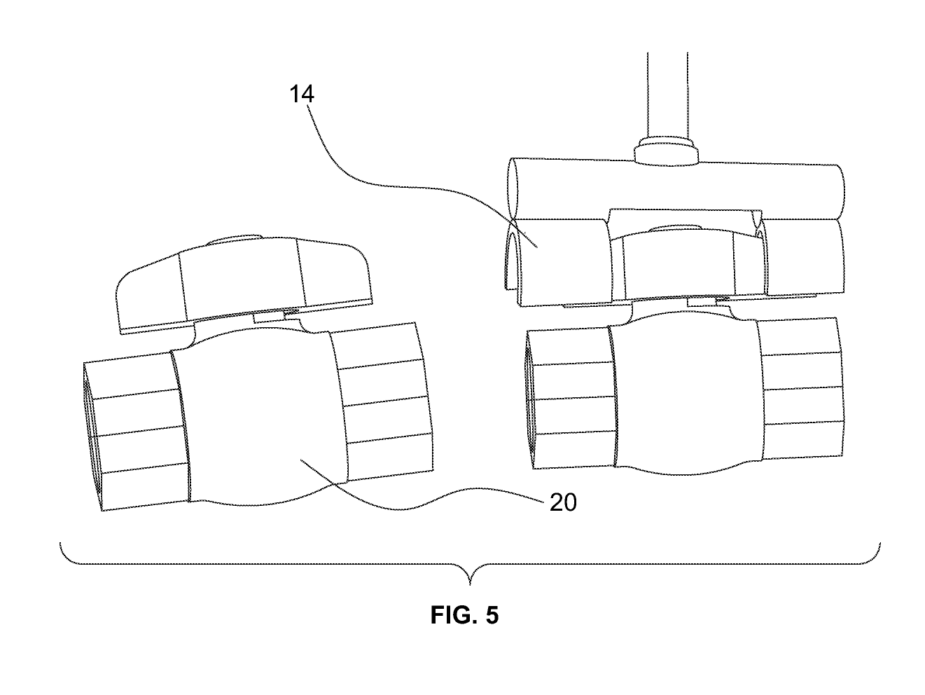

FIG. 5 is a close-up front view of clevises 14 fit on a valve's butterfly handle.

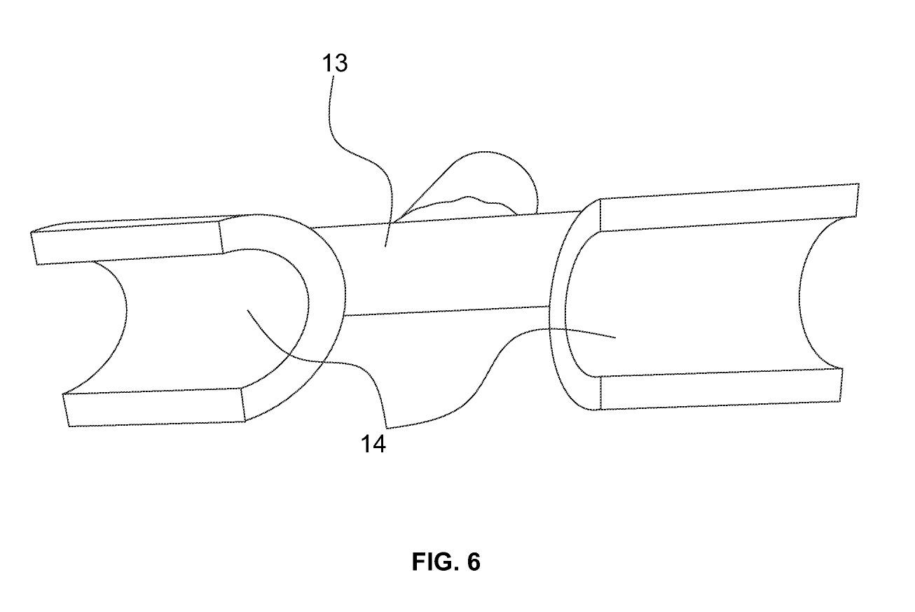

FIG. 6 is a close-up bottom view of clevises 14 of the embodiment of FIG. 1.

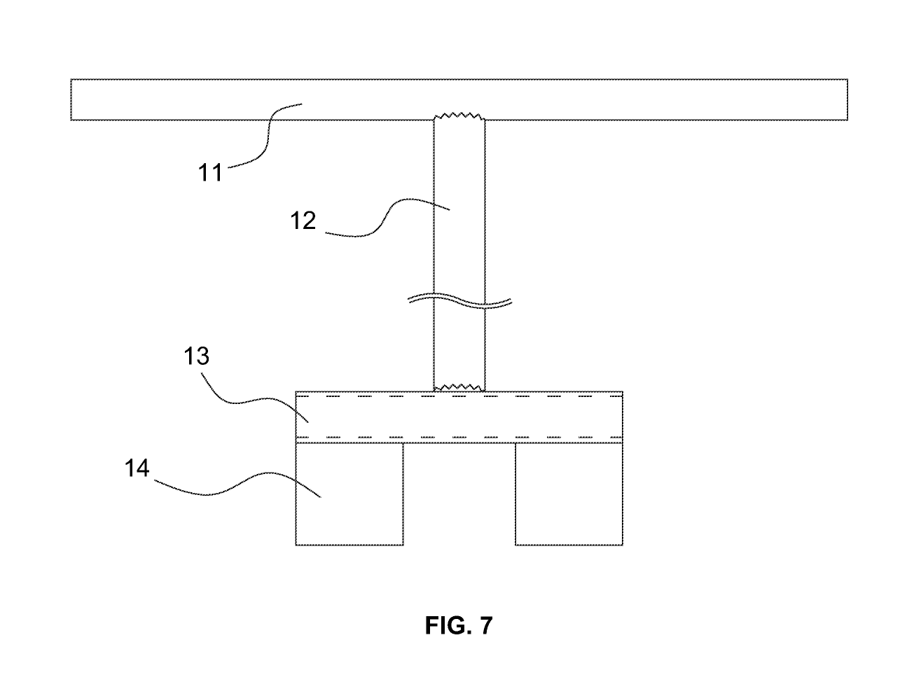

FIG. 7 illustrates making of the valve actuator of the embodiment of FIG. 1. The material needed for making this embodiment includes a round steel bar stock measuring about ½ inch, more or less, in internal diameter (ID), ⅝ inch, more or less, in outer diameter (OD) and about 3.5 ft, more or less, in length; a flat metal plate of about 3/16 inch, more or less, in thickness, and about 5 inches, more or less, in length; welding equipment; and plate metal bending equipment.

The procedures making the embodiment includes: Cutting the round steel bar stock into 3 pieces including a first piece of about 9½ inches in length, a second piece of about 25¾ inches in length; and a third piece of about 4 inches in length; welding the first piece at the center at an angle of about 90 degrees, to the top of the second piece, to form a tee handle which includes a horizontal bar 11 and a vertical shaft 12; welding the third piece at its center at an angle of about 90 degrees, to the bottom of the shaft 12, to form the horizontal bar 13 of the bottom tee; cutting the flat metal plate into 2 pieces; bending each piece of flat metal plate into inverted “U” shape and welding them to the bottom bar 13 forming a clevis 14 on each side of central shaft at a pre-determined distance (d). The first piece and third piece form the top and bottom horizontal bars 11, 13 which are parallel to each other and perpendicular to the second piece which forms the vertical shaft 12 of the embodiment.

In one embodiment, the clevis 14 is about 1¼ inches more or less in width (W) and about 1 inch more or less in length (L). The pre-determined distance (d) between the two clevises is about 1 11/16 inches, more or less which is designed for a 2.0 inches valve with a butterfly handle.

The length, ID, and OD of the top and bottom horizontal bars and the vertical shaft may vary. The length and width of the clevises may vary too. The pre-determined distance between the two clevises may also vary in order to fit various valves of various sizes.

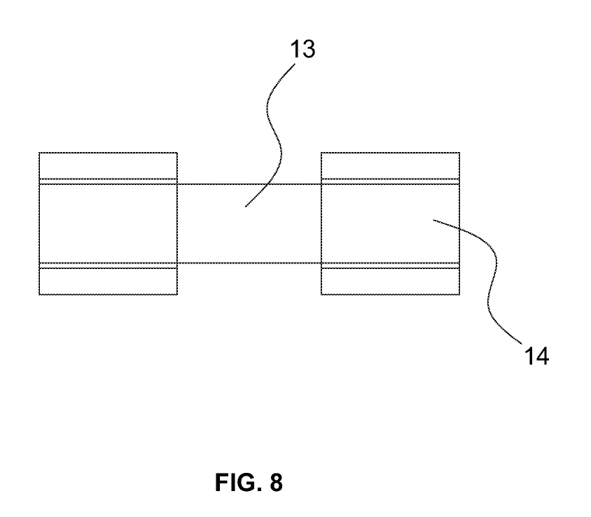

FIG. 8 is a close-up side view of clevises of the embodiment of FIG. 1.

The deluxe model would have two adjustable sliding clevises to fit over valves of different sizes.

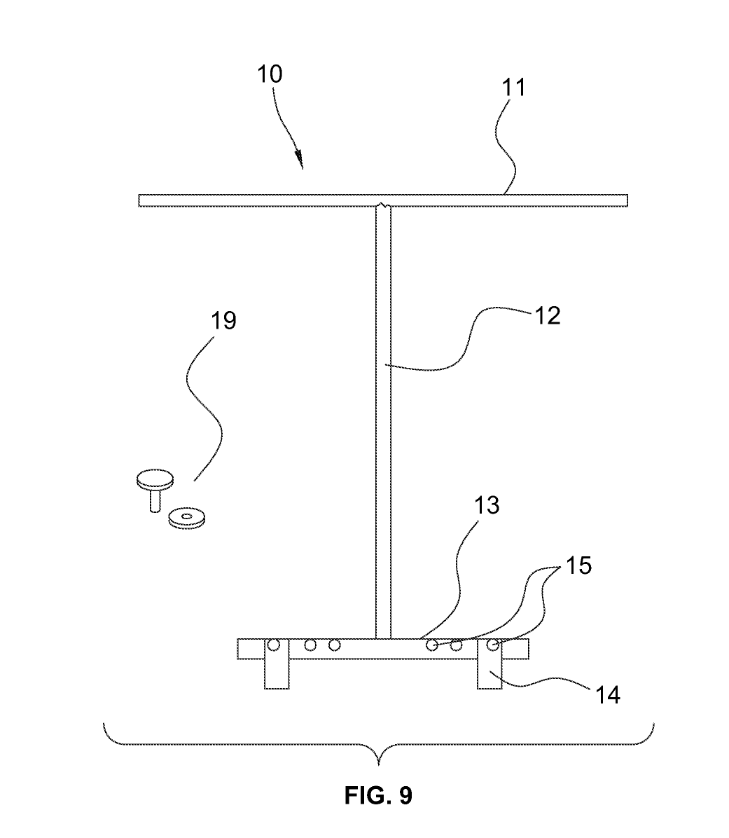

FIG. 9 is a front view of a valve actuator according to another embodiment of the present invention. This embodiment has an additional feature that the clevises 14 are slidably connected to the horizontal bottom bar 13 so that one valve actuator can be used for a variety of valve handles of various sizes. In use, the slidable clevises 14 are moving toward or away from the shaft 12 as desired and locked in place by locking members. In one embodiment, the bottom horizontal bar may have a plurality of holes 15 and each of clevises may have a hole in the middle. When the clevises move to the desired location the clevises can be secured by the locking members including but not limited to set screws or thumb screws 19. Other type of fastening mechanism can be used to secure the clevises in place to the bottom horizontal bar.

In another embodiment, the shaft is capable of adjusting the length vertically according to users' needs, and to achieve an optimal height.

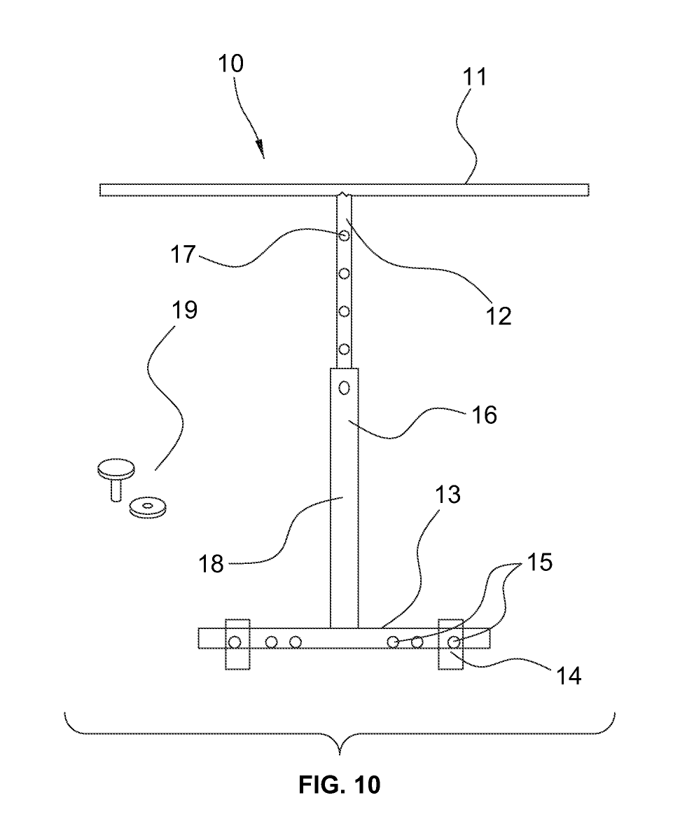

FIG. 10 is a front view of a valve actuator 10 according to another embodiment of the present invention. This embodiment has more features in addition to the features found in the embodiments described in the foregoing paragraphs. The height of the valve actuator 10 is adjustable. The embodiment comprises a tee-handle which includes a top horizontal bar 11 and a shaft 12 and a bottom tee which includes a vertical tube 16 and a horizontal bar 13. In one embodiment, the shaft has a plurality of holes 17 along its length. The vertical tube has one hole 18. The height of the valve actuator 10 can be adjusted by moving the shaft along the vertical tube until the desired height and locked the shaft in place by a locking member. A safety lock 19 such as set screws or thumb screws is provided to secure the shaft inside the vertical tube in place. The tee handle may be adjusted to different heights and locked into place by a clamp or with set screws or thumb screws.

In use, the tee-handle is inserted into the vertical tube and adjusted as desired and secured in place by the locking members. The slidable clevises are moving toward or away from the tube as desired and locked in position with the locking members. Said locking members include but are not limited to set screws or thumb screws.

Other mechanism to adjust the height of the valve actuator of the present invention includes telescopic mechanism known in the art.

In other embodiments, the handle may be a wheel handle instead of tee handle.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A long handled valve actuator for opening and closing a butterfly handled valve comprising:
a tee handle having a horizontal bar and a vertical shaft perpendicularly connected at its top to the center of the horizontal bar;
a bottom horizontal bar perpendicularly connected at its center to the bottom of the tee handle shaft and parallel with the tee handle horizontal bar; and
two inverted U-shaped members attached to the bottom horizontal bar on each side of the shaft.

2. The long handled valve actuator of claim 1, wherein the vertical shaft is connected to both horizontal bars by welding.

3. The long handled valve actuator of claim 2, wherein the two inverted U-shaped members are welded to the bottom horizontal bar in a predetermined distance to match a butterfly handle of a valve and the predetermined distance can vary according to a size of the butterfly handle of the valve to be operated.

4. The long handled valve actuator of claim 2, wherein the two inverted U-shaped members are slidably attached to the bottom horizontal bar in a manner such that the two inverted U-shaped members can slide along the bottom horizontal bar toward or away from the shaft to adjust the distance between each other in order to fit over the butterfly handle of one of valves of different sizes.

5. The long handled valve actuator of claim 4 further comprises locking members for securing the two inverted U-shaped members to the bottom horizontal bar once the two inverted U-shaped members are moved to a desired location.

6. The long handled valve actuator of claim 5, wherein the locking members include set screws or thumb screws.

7. The long handled valve actuator of claim 2, wherein the tee handle horizontal bar measures about ½ inch in internal diameter (ID) about ⅝ inch in outer diameter (OD) and about 9½ inches in length, the vertical shaft measures about ½ inch in ID about ⅝ inch in OD and about 25¾ inches in length, and the bottom horizontal bar measures about ½ inch in ID about ⅝ inch in OD and about 4 inches in length.

8. The long handled valve actuator of claim 7, wherein each of the two inverted U-shaped members is about 1 inch in width and about 1¼ inches in length and about 1 11/16 inches apart from each other.

9. The long handled valve actuator of claim 1, wherein the shaft has a telescopic mechanism to adjust the length; and locking members coupled to lock the shaft at a desired height.

10. A long handled valve actuator for opening and closing a butterfly handled valve comprising:
a handle having a top horizontal member and a vertical shaft perpendicularly connected at its top to the center of the top horizontal bar;
a bottom tee having a bottom horizontal bar and a vertical tube perpendicularly connected at its bottom to the center of the bottom horizontal bar;
locking members for securing the vertical shaft to the vertical tube;
two inverted U-shaped members slidably attached to the bottom horizontal bar on each side of the vertical tube to allow the two inverted U-shaped members to slide along the bottom horizontal bar toward or away from the vertical tube to adjust the distance between each other in order to fit over the butterfly handle of one of various sizes; and
locking members for securing the two inverted U-shaped members in place to the bottom horizontal bar;
wherein the vertical shaft is detachably attached to the vertical tube such that the height of the valve actuator is adjustable.

11. The long handled valve actuator of claim 10, wherein the locking members for securing the two inverted U-shaped members and for securing the vertical shaft to the vertical tube include set crews or thumb screws.

12. The long handled valve actuator of claim 10, wherein the handle horizontal member is a horizontal bar.

13. The long handled valve actuator of claim 11, wherein the vertical shaft has a plurality of holes along its length and the vertical tube has at least one hole along its length, the holes on the vertical shaft and tube being arranged in a manner when the shaft is inserted into the tube and the holes on the shaft and tube correspond, the bottom horizontal bar is parallel with the handle horizontal member.
